(19) United States
(12) Patent Application Publication
(10) Pub. No.: US 2017/0308290 A1
(43) Pub. Date: Oct. 26, 2017

(54) ICONOGRAPHIC SUGGESTIONS WITHIN A KEYBOARD

(71) Applicant: Google Inc., Mountain View, CA (US)

(72) Inventor: Rajan Patel, Mountain View, CA (US)

(21) Appl. No.: 15/133,316

(22) Filed: Apr. 20, 2016

(51) Int. Cl. G06F 3/0488; G06F 17/24; G06F 3/0484; G06F 3/0482; G06F 17/27; G06F 3/0481

(52) U.S. Cl. CPC G06F 3/04886; G06F 17/276; G06F 17/24; G06F 3/04817; G06F 3/04842; G06F 3/0482; G06F 3/04883

(57) ABSTRACT

A computing device is described that outputs for display, a graphical keyboard comprising a plurality of keys, and determines, based on a selection of one or more keys from the plurality of keys, text. The computing device predicts, based at least in part on the text, a candidate iconographic symbol, and determines whether to modify the text by replacing a portion of the text with the candidate iconographic symbol or appending the candidate iconographic symbol to the text. The computing device modifies, based on the determination, the text by either replacing the portion of the text with the candidate iconographic symbol or appending the candidate iconographic symbol to the text, and outputs, for display, the modified text.

### BACKGROUND

Despite being able to simultaneously execute several applications, some mobile computing devices can only present a graphical user interface (GUI) of a single application, at a time. To interact with multiple applications at once, a user of a mobile computing device may have to switch between different application GUIs. For example, a user of a mobile computing device may have to cease entering text in a messaging application and provide input to cause the device to toggle to a search application to search for a particular piece of information, such as an iconographic symbol (e.g., an emoji symbol), to use when composing a message or otherwise entering text.

### SUMMARY

In one example, a method includes outputting, by a mobile computing device, for display, a graphical keyboard comprising a plurality of keys; determining, by the mobile computing device, based on a selection of one or more keys from the plurality of keys, text; predicting, by the mobile computing device and based at least in part on the text, a candidate iconographic symbol; determining, by the mobile computing device, whether to modify the text by replacing a portion of the text with the candidate iconographic symbol or appending the candidate iconographic symbol to the text; modifying, by the mobile computing device and based on the determining, the text by either replacing the portion of the text with the candidate iconographic symbol or appending the candidate iconographic symbol to the text; and outputting, by the mobile computing device and for display at the display device, the modified text.

In another example, a computing device includes a presence-sensitive display, at least one processor, and a memory comprising instructions that when executed cause the at least one processor to output for display, a graphical keyboard comprising a plurality of keys; determine based on a selection of one or more keys from the plurality of keys, text; predict, based at least in part on the text, a candidate iconographic symbol; determine whether to modify the text by replacing a portion of the text with the candidate iconographic symbol or appending the candidate iconographic symbol to the text; modify, based on the determining, the text by either replacing the portion of the text with the candidate iconographic symbol or appending the candidate iconographic symbol to the text; and output, for display, the modified text.

In another example, a computer-readable storage medium encoded with instructions that, when executed by at least one processor of a computing device, cause the at least one processor to output for display, a graphical keyboard comprising a plurality of keys; determine based on a selection of one or more keys from the plurality of keys, text; predict, based at least in part on the text, a candidate iconographic symbol; determine whether to modify the text by replacing a portion of the text with the candidate iconographic symbol or appending the candidate iconographic symbol to the text; modify, based on the determining, the text by either replacing the portion of the text with the candidate iconographic symbol or appending the candidate iconographic symbol to the text; and output, for display, the modified text.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIGS. 1A-1E are conceptual diagrams illustrating an example computing device that is configured to present a graphical keyboard with integrated emoji suggestions, in accordance with one or more aspects of the present disclosure.

FIG. 2 is a block diagram illustrating an example computing device that is configured to present a graphical keyboard with integrated emoji suggestions, in accordance with one or more aspects of the present disclosure.

FIG. 3 is a block diagram illustrating an example computing device that outputs graphical content for display at a remote device, in accordance with one or more techniques of the present disclosure.

FIGS. 4A-4D are conceptual diagrams illustrating example graphical user interfaces of an example computing device that is configured to present a graphical keyboard with integrated emoji suggestions, in accordance with one or more aspects of the present disclosure.

FIG. 5 is a flowchart illustrating example operations of a computing device that is configured to present a graphical keyboard with integrated iconographic suggestions, in accordance with one or more aspects of the present disclosure.

### DETAILED DESCRIPTION

In general, this disclosure is directed to techniques for enabling a computing device to selectively append or replace text with one or more suggested iconographic symbols. For example, as a computing device detects input at a graphical keyboard of a graphical user interface (GUI), the computing device may determine text of an electronic communication (e.g., a chat conversation) and output the text for display within an edit region of the GUI. The computing device may further output, for display within the graphical keyboard, a graphical indication of a suggested iconographic symbol (e.g., within a suggestion region of the graphical keyboard) that is predicted to correspond to a portion of the text. After detecting input associated with the suggested iconographic symbol, the computing device may insert the iconographic symbol within the edit region.

In some situations a user may wish to append the text with the iconographic symbol (e.g., to provide emphasis to the text) whereas in other situations the user may wish to replace a portion of the text with the iconographic symbol (e.g., as a short hand text). Rather than require additional inputs from the user designating whether he or she wishes to append or replace a portion of the text with the iconographic symbol, the computing device relies on a model, integrated into the graphical keyboard, to automatically determine whether to modify the text by replacing the portion of the text with the iconographic symbol or appending the iconographic symbol to the portion of the text. That way, responsive to detecting input associated with the graphical indication of the iconographic symbol, the computing device may automatically modify the text by either replacing the portion of the text with the iconographic symbol or appending the iconographic symbol to the portion of the text and output the modified text for display.

By providing an iconographic symbol predicted to correspond to a portion of text, a user of the computing device may automatically obtain selectable iconographic symbols within the graphical keyboard, as the user is typing, rather than requiring the user to switch between different application GUIs to look-up corresponding iconographic symbols. Where the portion of the text is automatically replaced by the iconographic symbol, by actively determining whether to replace the text with the iconographic symbol or to append the iconographic symbol to the text, the user may utilize iconographic symbols without having to delete the portion of the text. Similarly, where the iconographic symbol is automatically appended to the portion of the text, by actively determining whether to replace the text with the iconographic symbol or to append the iconographic symbol to the text, the user may utilize iconographic symbols that are easier to understand with the context provided by the portion of the text. In this way, techniques of this disclosure may reduce the number of user inputs required to utilize iconographic symbols, which may simplify the user experience and may reduce power consumption of the computing device.

Throughout the disclosure, examples are described where a computing device and/or a computing system analyzes information (e.g., context, locations, speeds, search queries, etc.) associated with a computing device and a user of a computing device, only if the computing device receives permission from the user of the computing device to analyze the information. For example, in situations discussed below, before a computing device or computing system can collect or may make use of information associated with a user, the user may be provided with an opportunity to provide input to control whether programs or features of the computing device and/or computing system can collect and make use of user information (e.g., information about a user's current location, current speed, etc.), or to dictate whether and/or how to the device and/or system may receive content that may be relevant to the user. In addition, certain data may be treated in one or more ways before it is stored or used by the computing device and/or computing system, so that personally-identifiable information is removed. For example, a user's identity may be treated so that no personally identifiable information can be determined about the user, or a user's geographic location may be generalized where location information is obtained (such as to a city, ZIP code, or state level), so that a particular location of a user cannot be determined. Thus, the user may have control over how information is collected about the user and used by the computing device and computing system.

While described below with respect to emoji symbols, the techniques of this disclosure are equally applicable to other iconographic symbols. Some examples of iconographic symbols include, but are not necessarily limited to, emoji symbols, ASCII emoticons, special ASCII symbols, and the like.

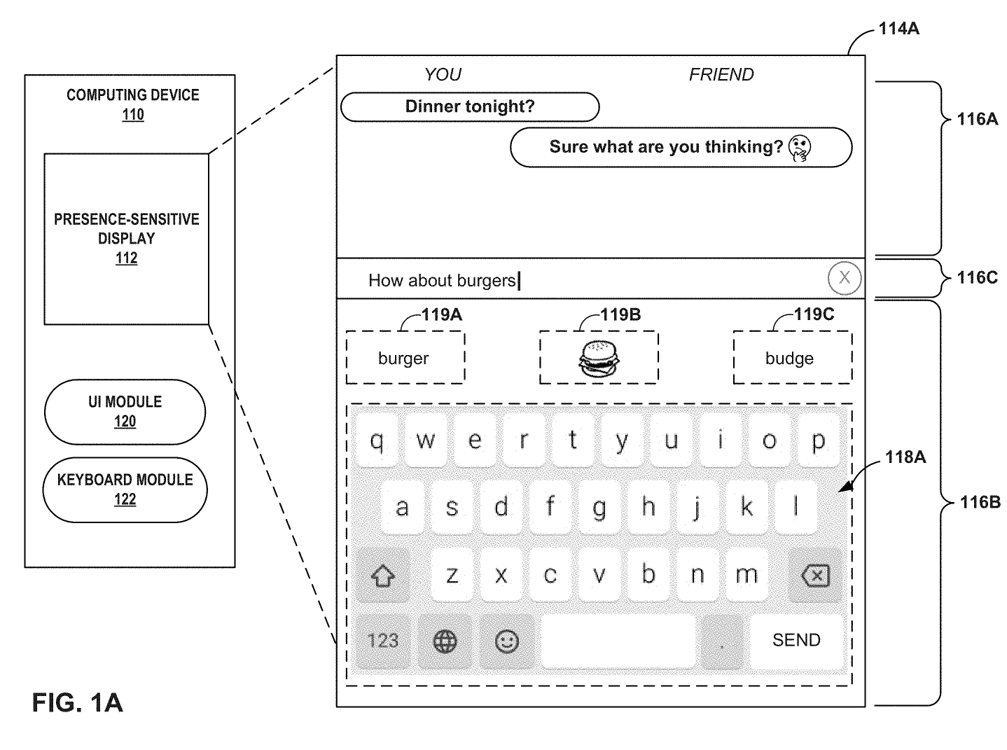

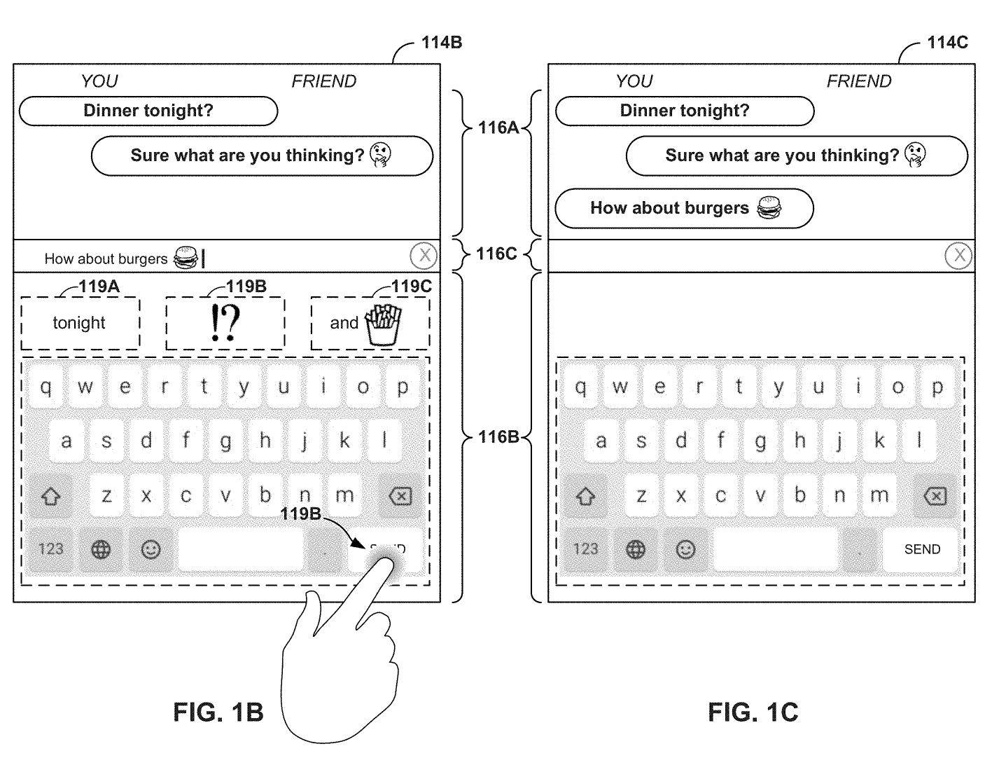

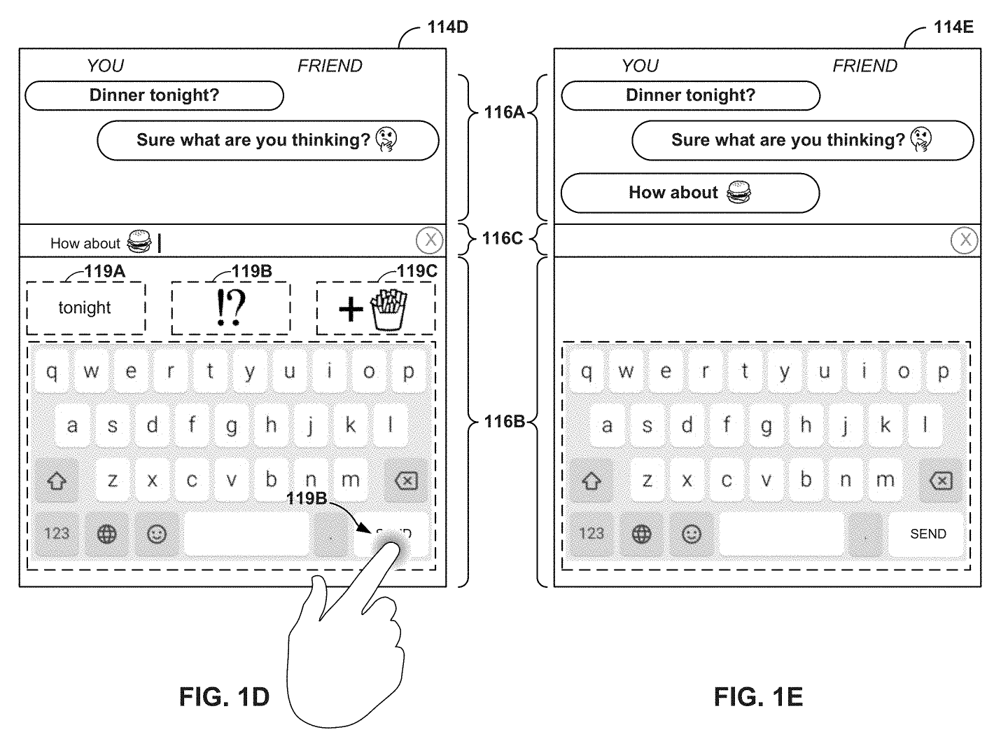

FIGS. 1A-1E are conceptual diagrams illustrating an example computing device 110 that is configured to present a graphical keyboard with integrated emoji suggestions, in accordance with one or more aspects of the present disclosure. Computing device 110 may represent a mobile device, such as a smart phone, a tablet computer, a laptop computer, computerized watch, computerized eyewear, computerized gloves, or any other type of portable computing device. Additional examples of computing device 110 include desktop computers, televisions, personal digital assistants (PDA), portable gaming systems, media players, e-book readers, mobile television platforms, automobile navigation and entertainment systems, vehicle (e.g., automobile, aircraft, or other vehicle) cockpit displays, or any other types of wearable and non-wearable, mobile or non-mobile computing devices that may output a graphical keyboard for display.

Computing device 110 includes a presence-sensitive display (PSD) 112, user interface (UI) module 120 and keyboard module 122. Modules 120 and 122 may perform operations described using software, hardware, firmware, or a mixture of hardware, software, and firmware residing in and/or executing at computing device 110. One or more processors of computing device 110 may execute instructions that are stored at a memory or other non-transitory storage medium of computing device 110 to perform the operations of modules 120 and 122. Computing device 110 may execute modules 120 and 122 as virtual machines executing on underlying hardware. Modules 120 and 122 may execute as one or more services of an operating system or computing platform. Modules 120 and 122 may execute as one or more executable programs at an application layer of a computing platform.

PSD 112 of computing device 110 may function as respective input and/or output devices for computing device 110. PSD 112 may be implemented using various technologies. For instance, PSD 112 may function as input devices using presence-sensitive input screens, such as resistive touchscreens, surface acoustic wave touchscreens, capacitive touchscreens, projective capacitance touchscreens, pressure sensitive screens, acoustic pulse recognition touchscreens, or another presence-sensitive display technology. PSD 112 may also function as output (e.g., display) devices using any one or more display devices, such as liquid crystal displays (LCD), dot matrix displays, light emitting diode (LED) displays, organic light-emitting diode (OLED) displays, e-ink, or similar monochrome or color displays capable of outputting visible information to a user of computing device 110.

PSD 112 may detect input (e.g., touch and non-touch input) from a user of respective computing device 110. PSD 112 may detect indications of input by detecting one or more gestures from a user (e.g., the user touching, pointing, and/or swiping at or near one or more locations of PSD 112 with a finger or a stylus pen). PSD 112 may output information to a user in the form of a user interface (e.g., user interface 114A), which may be associated with functionality provided by computing device 110. Such user interfaces may be associated with computing platforms, operating systems, applications, and/or services executing at or accessible from computing device 110 (e.g., electronic message applications, chat applications, Internet browser applications, mobile or desktop operating systems, social media applications, electronic games, and other types of applications). For example, PSD 112 may present user interface 114A which, as shown in FIG. 1A, is a graphical user interface of a chat application executing at computing device 110 and includes various graphical elements displayed at various locations of PSD 112.

Although shown as a chat user interface, user interface 114A may be any graphical user interface which includes a graphical keyboard with integrated search features. User interface 114A includes output region 116A, graphical keyboard 116B, and edit region 116C. A user of computing device 110 may provide input at graphical keyboard 116B to produce textual characters within edit region 116C that form the content of the electronic messages displayed within output region 116A. The messages displayed within output region 116A form a chat conversation between a user of computing device 110 and a user of a different computing device.

UI module 120 manages user interactions with PSD 112 and other components of computing device 110. In other words, UI module 120 may act as an intermediary between various components of computing device 110 to make determinations based on user input detected by PSD 112 and generate output at PSD 112 in response to the user input. UI module 120 may receive instructions from an application, service, platform, or other module of computing device 110 to cause PSD 112 to output a user interface (e.g., user interface 114A). UI module 120 may manage inputs received by computing device 110 as a user views and interacts with the user interface presented at PSD 112 and update the user interface in response to receiving additional instructions from the application, service, platform, or other module of computing device 110 that is processing the user input.

Keyboard module 122 represents an application, service, or component executing at or accessible to computing device 110 that provides computing device 110 with a graphical keyboard having integrated search features. Keyboard module 122 may switch between operating in text-entry mode in which keyboard module 122 functions similar to a traditional graphical keyboard, or a search mode in which keyboard module 122 performs various integrated search functions.

In some examples, keyboard module 122 may be a stand-alone application, service, or module executing at computing device 110 and in other examples, keyboard module 122 may be a sub-component thereof. For example, keyboard module 122 may be integrated into a chat or messaging application executing at computing device 110 whereas in other examples, keyboard module 122 may be a stand-alone application or subroutine that is invoked by an application or operating platform of computing device 110 any time an application or operating platform requires graphical keyboard input functionality. In some examples, computing device 110 may download and install keyboard module 122 from an application repository of a service provider (e.g., via the Internet). In other examples, keyboard module 122 may be preloaded during production of computing device 110.

When operating in text-entry mode, keyboard module 122 of computing device 110 may perform traditional, graphical keyboard operations used for text-entry, such as: generating a graphical keyboard layout for display at PSD 112, mapping detected inputs at PSD 112 to selections of graphical keys, determining characters based on selected keys, and predicting or autocorrecting words and/or phrases based on the characters determined from selected keys.

Graphical keyboard 116B includes graphical elements displayed as graphical keys 118A. Keyboard module 122 may output information to UI module 120 that specifies the layout of graphical keyboard 116B within user interface 114A. For example, the information may include instructions that specify locations, sizes, colors, and other characteristics of graphical keys 118A. Based on the information received from keyboard module 122, UI module 120 may cause PSD 112 display graphical keyboard 116B as part of user interface 114A.

Each key of graphical keys 118A may be associated with a respective character (e.g., a letter, number, punctuation, or other character) displayed within the key. A user of computing device 110 may provide input at locations of PSD 112 at which one or more of graphical keys 118A is displayed to input content (e.g., characters, search results, etc.) into edit region 116C (e.g., for composing messages that are sent and displayed within output region 116A or for inputting a search query that computing device 110 executes from within graphical keyboard 116B). Keyboard module 122 may receive information from UI module 120 indicating locations associated with input detected by PSD 112 that are relative to the locations of each of the graphical keys. Using a spatial and/or language model, keyboard module 122 may translate the inputs to selections of keys and characters, words, and/or phrases.

For example, PSD 112 may detect an indication of a user input as a user of computing device 110 provides user inputs at or near a location of PSD 112 where PSD 112 presents graphical keys 118A. UI module 120 may receive, from PSD 112, an indication of the user input at PSD 112 and output, to keyboard module 122, information about the user input. Information about the user input may include an indication of one or more touch events (e.g., locations and other information about the input) detected by PSD 112.

Based on the information received form UI module 120, keyboard module 122 may map detected inputs at PSD 112 to selections of graphical keys 118A, determine characters based on selected keys 118A, and predict or autocorrect words and/or phrases determined based on the characters associated with the selected keys 118A. For example, keyboard module 122 may include a spatial model that may determine, based on the locations of keys 118A and the information about the input, the most likely one or more keys 118A being selected. Responsive to determining the most likely one or more keys 118A being selected, keyboard module 122 may determine one or more characters, words, and/or phrases. For example, each of the one or more keys 118A being selected from a user input at PSD 112 may represent an individual character or a keyboard operation. Keyboard module 122 may determine a sequence of characters selected based on the one or more selected keys 118A. In some examples, keyboard module 122 may apply a language model to the sequence of characters to determine the most likely candidate letters, morphemes, words, and/or phrases that a user is trying to input based on the selection of keys 118A.

Keyboard module 122 may send the sequence of characters and/or candidate words and phrases to UI module 120 and UI module 120 may cause PSD 112 to present the characters and/or candidate words determined from a selection of one or more keys 118A as text within edit region 116C. In some examples, when functioning as a traditional keyboard for performing text-entry operations, and in response to receiving a user input at graphical keys 118A (e.g., as a user is typing at graphical keyboard 116B to enter text within edit region 116C), keyboard module 122 may cause UI module 120 to display the candidate words and/or phrases as one or more selectable spelling corrections and/or selectable word or phrase suggestions within suggestion region 119A-119C (collectively, “suggestion regions 119”).

In addition to determining word and/or phrase suggestions keyboard module 122 may determine candidate emoji symbols based at least in part on the text entered within edit region 116C (e.g., candidate emoji symbols that correspond to at least a portion of the text entered within edit region 116C and/or one of the candidate words and/or phrases determined based on the selection of keys 118A). For instance, keyboard module 122 may apply an emoji-trained language model to the text entered within edit region 116C to determine one or more candidate emoji symbols predicted to correspond to at least a portion of the text entered within edit region 116C. In some examples, keyboard module 122 may cause UI module 120 to display the candidate emoji symbols as one or more selectable emoji symbols within one or more of suggestion regions 119. For purposes of this disclosure, the term emoji symbol may refer to a pictograph that can be used inline in text. For example, The Unicode Standard, such as The Unicode Version 8.0.0, contains an example list of emoji symbols that may be determined by keyboard module 122.

In some examples, keyboard module 122 may rank the candidate emoji symbols and the candidate words and/or phrases and cause UI module 120 to display the most probable candidate emoji symbols, candidate words, and/or candidate phrases within suggestion regions 119. In some examples, keyboard module 122 may cause UI module 120 to display the most probable candidate emoji symbols, candidate words, and/or candidate phrases within suggestion regions 119 without regard for whether the most displayed candidates are emoji symbols, words, or phrases. In some examples, keyboard module 122 may reserve one or more suggestion regions of suggestion regions 119 for candidate emoji symbols. For instance, keyboard module 122 may reserve suggestion region 119B for candidate emoji symbols with remaining suggestion regions 119A and 119C used to display candidate words and/or phrases.

Keyboard module 122 may receive information from UI module 120 indicating a selection of a particular suggestion region of suggestion regions 119. For example, PSD 112 may detect an indication of a user input as a user of computing device 110 provides user inputs at or near a location of PSD 112 where PSD 112 presents the particular suggestion region of suggestion regions 199. UI module 120 may receive, from PSD 112, an indication of the user input at PSD 112 and output, to keyboard module 122, information about the user input. Information about the user input may include an indication of one or more touch events (e.g., locations and other information about the input) detected by PSD 112.

Responsive to receiving the information indicating the selection of the particular suggestion region of suggestion regions 119, keyboard module 122 may modify the text within edit region 116C based on the candidate displayed within the particular suggestion region. When the candidate displayed within the particular suggestion region is a complete word or a phrase based on a partial word or phrase within edit region 116C, keyboard module 122 may modify the text within edit region 116C by simply replacing the partial word or phrase with the complete candidate word or phrase. For example, as shown in FIG. 1A, keyboard module 122 may replace “burgers” within edit region 116C with the word “burger” in response to receiving information indicating the selection of suggestion region 119A.

However, when the candidate displayed within the particular suggestion region is an emoji symbol, it may not be desirable for keyboard module 122 to always modify the text within edit region 116C by replacing the portion of the text that corresponds to the candidate emoji symbol with the candidate emoji symbol. For instance, in some examples, it may be desirable to append the candidate emoji symbol to the portion of the text that corresponds to the candidate emoji symbol because replacing the portion of the text that corresponds to the candidate emoji symbol with the candidate emoji symbol may obfuscate the meaning of the text/emoji symbol. On the other hand, in some examples, it may be desirable for keyboard module 122 to modify the text within edit region 116C by replacing the portion of the text that corresponds to the candidate emoji symbol with the candidate emoji symbol because it may be redundant to include both the portion of the text that corresponds to the candidate emoji symbol and the candidate emoji symbol.

In accordance with one or more techniques of this disclosure, as opposed to always replacing the portion of the text that corresponds to the candidate emoji symbol with the candidate emoji symbol or always appending the candidate emoji symbol to the portion of the text, keyboard module 122 may selectively determine whether to replace the portion of the text that corresponds to the candidate emoji symbol with the candidate emoji symbol or append the candidate emoji symbol to the portion of the text. In some examples, keyboard module 122 may determine whether to append or replace based on an emoji-trained language model, such as the emoji-trained language model used by keyboard module 122 to predict the candidate emoji symbol.

In operation, a user may rely on computing device 110 to exchange electronic communications (e.g., text messages) with a device that is associated with a friend. As shown in FIG. 1A, after sending a message to the device associated with the friend that asks “Dinner tonight?”, computing device 110 may receive a message from the device associated with the friend that states “Sure what are you thinking?[thinking face emoji (e.g., Unicode U+1F914)]”. Computing device 110 may output user interface 114A for display at PSD 112 which includes a message bubble with the message sent to the device associated with the friend and the message received from the device associated with the friend.

After viewing the message displayed at PSD 112, the user of computing device 110 may provide input to select keys 118A to compose a reply message, for instance, by gesturing at or near locations of PSD 112 at which keys 118A are displayed. Computing device 110 may determine, based on a selection of one or more keys 118A, one or more candidate words. For example, as the user of computing device provides input at keys 118A, keyboard module 122 may receive an indication of the input from UI module 120 and determine from the input, a selection of the keys 118A. Using a spatial and/or language model, keyboard module 122 may determine, based on the selection, that the user likely inputted the text “How about burgers”.

Computing device 110 may output, for display within edit region 116C, textual characters “How about burgers” as an indication of the candidate word that computing device 110 derived from the user input. For example, keyboard module 122 may send information to UI module 120 causing UI module 120 to present the text “How about burgers” within edit region 116C.

Computing device 110 may determine the most likely candidate letters, morphemes, words, and/or phrases that a user is trying to input based on the selection of keys 118A and determine candidate emoji symbols that correspond to at least a portion of the text entered within edit region 116C and/or one of the candidate words and/or phrases determined based on the selection of keys 118A. Computing device 110 may output, for display at PSD 112 and within suggestion regions 119, the most probable candidate emoji symbols, candidate words, and/or candidate phrases. As shown in FIG. 1A, based on the word “burgers” entered within edit region 116C, computing device 110 may output the text “burger” in suggestion region 119A, the hamburger emoji (e.g., Unicode U+1F354) in suggestion region 119B, and the text “budge” in suggestion region 119C. As discussed in greater detail below, in some examples, computing device 110 may use an emoji-trained language model to predict the most probable candidate emoji symbols.

After viewing the candidates displayed at PSD 112, the user of computing device 110 may provide input to select one of the candidates, for instance, by gesturing at or near locations of PSD 112 at which suggestion regions 119 are displayed. In response to a selection of a suggestion region of suggestion regions 119, computing device 110 may modify the text displayed within edit region 116C based on the candidate corresponding to the selected suggestion region. In the example of FIG. 1A, in response to a selection of suggestion region 119B, computing device 110 may modify the text displayed within edit region 116C based on the hamburger emoji (e.g., Unicode U+1F354).

As discussed above and in accordance with one or more techniques of this disclosure, computing device 110 may selectively determine whether to replace “burgers” (i.e., the portion of the text that corresponds to the candidate emoji symbol) with the hamburger emoji (i.e., the candidate emoji symbol) or append the hamburger emoji to the portion of the text. As discussed in greater detail below, in some examples, computing device 110 may determine whether to append or replace based on an emoji-trained language model, such as the emoji-trained language model used by keyboard module 122 to predict the candidate emoji symbol.

As shown in FIG. 1B, where computing device 110 determines to append the candidate emoji symbol to the text, computing device 110 may modify the text in edit region 116C by appending the hamburger emoji to the text “burgers”. After modifying the text in edit region 116C with the candidate emoji symbol, computing device 110 may detect input 119B (e.g., a tap gesture) at the “SEND” key of keys 118A. For example, UI module 120 may determine that PSD 112 detected input 119B at or near a location at which PSD 112 presents the “SEND” key of graphical keyboard 116B of user interface 114B.

As shown in FIG. 1C, computing device 110 may output the content of edit region 116C as a message to the device associate with the friend and may display the message within output region 116A. For example, UI module 120 may send information to the chat application associated with user interfaces 114C and the chat application may package the contents of edit region 116C into an electronic message format and cause computing device 110 to send the electronic message to the device associated with the friend. While sending the electronic message, the chat application may cause UI module 120 to present a graphical indication of the electronic message at output region 116A.

As shown in FIG. 1D, where computing device 110 determines to append the candidate emoji symbol to the text, computing device 110 may modify the text in edit region 116C by replacing the text “burgers” with the hamburger emoji. After modifying the text in edit region 116C with the candidate emoji symbol, computing device 110 may detect input 119B (e.g., a tap gesture) at the “SEND” key of keys 118A. For example, UI module 120 may determine that PSD 112 detected input 119B at or near a location at which PSD 112 presents the “SEND” key of graphical keyboard 116B of user interface 114B.

As shown in FIG. 1E, computing device 110 may output the content of edit region 116C as a message to the device associate with the friend and may display the message within output region 116A. For example, UI module 120 may send information to the chat application associated with user interfaces 114E and the chat application may package the contents of edit region 116C into an electronic message format and cause computing device 110 to send the electronic message to the device associated with the friend. While sending the electronic message, the chat application may cause UI module 120 to present a graphical indication of the electronic message at output region 116A.

By providing an emoji symbol predicted to correspond to a portion of text, a user of computing device 110 may automatically obtain selectable emoji symbols within the graphical keyboard, as the user is typing, rather than requiring the user to switch between different application GUIs to look-up corresponding emoji symbols. Where the portion of the text is automatically replaced by the emoji symbol, by actively determining whether to replace the text with the emoji symbol or to append the emoji symbol to the text, the user may utilize emoji symbols without having to delete the portion of the text. Similarly, where the emoji symbol is automatically appended to the portion of the text, by actively determining whether to replace the text with the emoji symbol or to append the emoji symbol to the text, the user may utilize emoji symbols that are easier to understand with the context provided by the portion of the text. In this way, techniques of this disclosure may reduce the number of user inputs required to utilize emoji symbols, which may simplify the user experience and may reduce power consumption of computing device 110.

As indicated above, keyboard module 122 may execute as a stand-alone application, service, or module executing at computing device 110 or as a single, integrated sub-component thereof. Therefore, if keyboard module 122 forms part of a chat or messaging application executing at computing device 110, keyboard module 122 may provide the chat or messaging application with text-entry capability. Similarly, if keyboard module 122 is a stand-alone application or subroutine that is invoked by an application or operating platform of computing device 110 any time an application or operating platform requires graphical keyboard input functionality, keyboard module 122 may provide the invoking application or operating platform with text-entry capability.

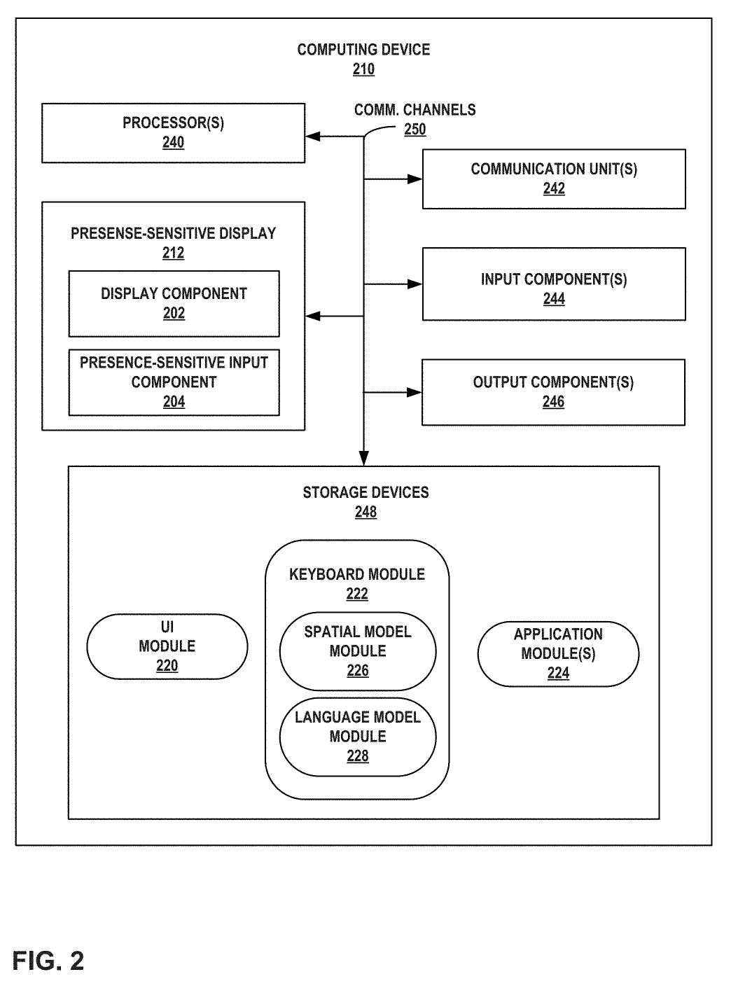

FIG. 2 is a block diagram illustrating computing device 210 as an example computing device that is configured to present a graphical keyboard with integrated emoji suggestions, in accordance with one or more aspects of the present disclosure. Computing device 210 of FIG. 2 is described below as an example of computing device 110 of FIGS. 1A-1E. FIG. 2 illustrates only one particular example of computing device 210, and many other examples of computing device 210 may be used in other instances and may include a subset of the components included in example computing device 210 or may include additional components not shown in FIG. 2.

As shown in the example of FIG. 2, computing device 210 includes PSD 212, one or more processors 240, one or more communication units 242, one or more input components 244, one or more output components 246, and one or more storage components 248. Presence-sensitive display 212 includes display component 202 and presence-sensitive input component 204. Storage components 248 of computing device 210 include UI module 220, keyboard module 222, and one or more application modules 224. Keyboard module 122 may include spatial model (“SM”) module 226, and language model (“LM”) module 228. Communication channels 250 may interconnect each of the components 212, 240, 242, 244, 246, 248, 220, 222, 224, 226, and 228 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on the one or more networks. Examples of communication units 242 include a network interface card (e.g. such as an Ethernet card), an optical transceiver, a radio frequency transceiver, a GPS receiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 242 of computing device 210, in one example, includes a presence-sensitive input device (e.g., a touch sensitive screen, a PSD), mouse, keyboard, voice responsive system, video camera, microphone or any other type of device for detecting input from a human or machine. In some examples, input components 242 may include one or more sensor components one or more location sensors (GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., microphone, camera, infrared proximity sensor, hygrometer, and the like). Other sensors may include a heart rate sensor, magnetometer, glucose sensor, hygrometer sensor, olfactory sensor, compass sensor, step counter sensor, to name a few other non-limiting examples.

One or more output components 246 of computing device 110 may generate output. Examples of output are tactile, audio, and video output. Output components 246 of computing device 210, in one example, includes a PSD, sound card, video graphics adapter card, speaker, cathode ray tube (CRT) monitor, liquid crystal display (LCD), or any other type of device for generating output to a human or machine.

PSD 212 of computing device 210 is similar to PSD 112 of computing device 110 and includes display component 202 and presence-sensitive input component 204. Display component 202 may be a screen at which information is displayed by PSD 212 and presence-sensitive input component 204 may detect an object at and/or near display component 202. As one example range, presence-sensitive input component 204 may detect an object, such as a finger or stylus that is within two inches or less of display component 202. Presence-sensitive input component 204 may determine a location (e.g., an [x, y] coordinate) of display component 202 at which the object was detected. In another example range, presence-sensitive input component 204 may detect an object six inches or less from display component 202 and other ranges are also possible. Presence-sensitive input component 204 may determine the location of display component 202 selected by a user's finger using capacitive, inductive, and/or optical recognition techniques. In some examples, presence-sensitive input component 204 also provides output to a user using tactile, audio, or video stimuli as described with respect to display component 202. In the example of FIG. 2, PSD 212 may present a user interface (such as graphical user interface 114A of FIG. 1A).

While illustrated as an internal component of computing device 210, PSD 212 may also represent and an external component that shares a data path with computing device 210 for transmitting and/or receiving input and output. For instance, in one example, PSD 212 represents a built-in component of computing device 210 located within and physically connected to the external packaging of computing device 210 (e.g., a screen on a mobile phone). In another example, PSD 212 represents an external component of computing device 210 located outside and physically separated from the packaging or housing of computing device 210 (e.g., a monitor, a projector, etc. that shares a wired and/or wireless data path with computing device 210).

PSD 212 of computing device 210 may detect two-dimensional and/or three-dimensional gestures as input from a user of computing device 210. For instance, a sensor of PSD 212 may detect a user's movement (e.g., moving a hand, an arm, a pen, a stylus, etc.) within a threshold distance of the sensor of PSD 212. PSD 212 may determine a two or three dimensional vector representation of the movement and correlate the vector representation to a gesture input (e.g., a hand-wave, a pinch, a clap, a pen stroke, etc.) that has multiple dimensions. In other words, PSD 212 can detect a multi-dimension gesture without requiring the user to gesture at or near a screen or surface at which PSD 212 outputs information for display. Instead, PSD 212 can detect a multi-dimensional gesture performed at or near a sensor which may or may not be located near the screen or surface at which PSD 212 outputs information for display.

One or more processors 240 may implement functionality and/or execute instructions associated with computing device 210. Examples of processors 240 include application processors, display controllers, auxiliary processors, one or more sensor hubs, and any other hardware configure to function as a processor, a processing unit, or a processing device. Modules 220, 222, 224, 226, and 228 may be operable by processors 240 to perform various actions, operations, or functions of computing device 210. For example, processors 240 of computing device 210 may retrieve and execute instructions stored by storage components 248 that cause processors 240 to perform the operations modules 220, 222, 224, 226, and 228. The instructions, when executed by processors 240, may cause computing device 210 to store information within storage components 248.

One or more storage components 248 within computing device 210 may store information for processing during operation of computing device 210 (e.g., computing device 210 may store data accessed by modules 220, 222, 224, 226, and 228 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220, 222, 224, 226, and 228. Storage components 248 may include a memory configured to store data or other information associated with modules 220, 222, 224, 226, and 228.

UI module 220 may include all functionality of UI module 120 of computing device 110 of FIGS. 1A-1E and may perform similar operations as UI module 120 for managing a user interface (e.g., user interface 114A) that computing device 210 provides at presence-sensitive display 212 for handling input from a user. For example, UI module 220 of computing device 210 may query keyboard module 222 for a keyboard layout (e.g., an English language QWERTY keyboard, etc.). UI module 220 may transmit a request for a keyboard layout over communication channels 250 to keyboard module 222. Keyboard module 222 may receive the request and reply to UI module 220 with data associated with the keyboard layout. UI module 220 may receive the keyboard layout data over communication channels 250 and use the data to generate a user interface. UI module 220 may transmit a display command and data over communication channels 250 to cause PSD 212 to present the user interface at PSD 212.

In some examples, UI module 220 may receive an indication of one or more user inputs detected at PSD 212 and may output information about the user inputs to keyboard module 222. For example, PSD 212 may detect a user input and send data about the user input to UI module 220. UI module 220 may generate one or more touch events based on the detected input. A touch event may include information that characterizes user input, such as a location component (e.g., [x,y] coordinates) of the user input, a time component (e.g., when the user input was received), a force component (e.g., an amount of pressure applied by the user input), or other data (e.g., speed, acceleration, direction, density, etc.) about the user input.

Based on location information of the touch events generated from the user input, UI module 220 may determine that the detected user input is associated the graphical keyboard. UI module 220 may send an indication of the one or more touch events to keyboard module 222 for further interpretation. Keyboard module 22 may determine, based on the touch events received from UI module 220, that the detected user input represents an initial selection of one or more keys of the graphical keyboard.

Application modules 224 represent all the various individual applications and services executing at and accessible from computing device 210 that may rely on a graphical keyboard having integrated search features. A user of computing device 210 may interact with a graphical user interface associated with one or more application modules 224 to cause computing device 210 to perform a function. Numerous examples of application modules 224 may exist and include, a fitness application, a calendar application, a personal assistant or prediction engine, a search application, a map or navigation application, a transportation service application (e.g., a bus or train tracking application), a social media application, a game application, an e-mail application, a chat or messaging application, an Internet browser application, or any and all other applications that may execute at computing device 210.

Keyboard module 222 may include all functionality of keyboard module 122 of computing device 110 of FIGS. 1A-1E and may perform similar operations as keyboard module 122 for providing a graphical keyboard having integrated search features. Keyboard module 222 may include various submodules, such as SM module 226 and LM module 228, which may perform the functionality of keyboard module 222.

SM module 226 may receive one or more touch events as input, and output a character or sequence of characters that likely represents the one or more touch events, along with a degree of certainty or spatial model score indicative of how likely or with what accuracy the one or more characters define the touch events. In other words, SM module 226 may infer touch events as a selection of one or more keys of a keyboard and may output, based on the selection of the one or more keys, a character or sequence of characters.

When keyboard module 222 operates in text-entry mode, LM module 228 may receive a character or sequence of characters as input, and output one or more candidate characters, words, or phrases that LM module 228 identifies from a lexicon as being potential replacements for a sequence of characters that LM module 228 receives as input for a given language context (e.g., a sentence in a written language). Keyboard module 222 may cause UI module 220 to present one or more of the candidate words at suggestion regions 118C of user interface 114A.

The lexicon of computing device 210 may include a list of words within a written language vocabulary (e.g., a dictionary). For instance, the lexicon may include a database of words (e.g., words in a standard dictionary and/or words added to a dictionary by a user or computing device 210. LM module 228 may perform a lookup in the lexicon, of a character string, to identify one or more letters, words, and/or phrases that include parts or all of the characters of the character string. For example, LM module 228 may assign a language model probability or a similarity coefficient (e.g., a Jaccard similarity coefficient) to one or more candidate words located at a lexicon of computing device 210 that include at least some of the same characters as the inputted character or sequence of characters. The language model probability assigned to each of the one or more candidate words indicates a degree of certainty or a degree of likelihood that the candidate word is typically found positioned subsequent to, prior to, and/or within, a sequence of words (e.g., a sentence) generated from text input detected by presence-sensitive input component 204 prior to and/or subsequent to receiving the current sequence of characters being analyzed by LM module 228. In response to determining the one or more candidate words, LM module 228 may output the one or more candidate words from the lexicon data that have the highest similarity coefficients.

In some examples, the lexicon of computing device 210 may include a plurality of emoji symbols and LM module 228 is an emoji-trained language model. For instance, LM module 228 may assign a language model probability, score, or a similarity coefficient to one or more candidate emoji symbols that indicates a degree of certainty or a degree of likelihood that the candidate emoji symbol is typically found positioned subsequent to, prior to, in-place of, and/or within, a sequence of words (e.g., a sentence) generated from text input detected by presence-sensitive input component 204 that may or may not include the current sequence of characters being analyzed by LM module 228. In response to determining the one or more candidate emoji symbols, LM module 228 may output the one or more candidate emoji symbols from the lexicon data that have the highest similarity coefficients.

In some examples, the language model used by LM module 228 to assign a language model probability or a similarity coefficient to one or more candidate emoji symbols may indicate a frequency at which the one or more candidate emoji symbols co-occur with a particular string of text. The greater the frequency at which the one or more candidate emoji symbols co-occur with the particular string of text, the greater the probability that the one or more candidate emoji symbols correspond to the particular string of text. Generally, LM module 228 may use a lift calculation that is based on the probability of a particular emoji symbol and n-gram co-occurring in text and the probability of just that n-gram occurring in text. For instance, if P{N} represents the probability of an n-gram occurring in a message and P{E, N} represents the probability of a particular emoji symbol and n-gram appearing in the same message, LM module 228 may calculate the lift by dividing the probability of the particular emoji symbol and n-gram appearing in the message by the probability of the n-gram occurring in the message (i.e., P{E, N}/P{N}). In some examples, LM module 228 may apply smoothing priors to each probability (e.g., in situations where the model has only been trained on small amounts of training data).

In some examples, the language model used by LM module 228 may rely on artificial intelligence and machine learning techniques to better predict emoji symbols that correspond to portions of text. The language model of LM module 228 may be trained based on text and emoji symbols entered by a large group of users and based on the training, generate rules for matching emoji symbols for different portions of text.

For instance, a corpus of text and emoji symbols entered by a large group of users may indicate that the word “love” has a high probability of corresponding to the heart emoji symbol (e.g., Unicode U+2764), that the word “haha” has a high probability of corresponding to the laughing emoji (e.g., Unicode U+1F602), and/or that the n-gram “united states” has a high probability of corresponding to the United States flag emoji (e.g., Unicode U+1F1FA). The language model of LM module 228 may generate global rules for associating textual words to the frequently used emoji symbols. In some examples, the language model may be further refined based on text and emoji symbols entered by a user of computing device 210 (e.g., based on emoji relationships that the individual user might use). For example, if the user of computing device 210 enters the one-hundred emoji (e.g., Unicode U+1F4AF) after the text “awesome”, LM module 228 may update the language model to increase the probability that the text “awesome” corresponds to the one-hundred emoji symbol (e.g., increase P{E,N} for the one-hundred emoji symbol and the test “awesome”). In this way, the language model of LM module 228 may generate local rules (e.g., user and/or device specific) for associating textual words to the frequently used emoji symbols. Additionally, by initially training the language model based on text and emoji symbols entered by a large group of users and refining the language model based on text and emoji symbols entered by a user of computing device 210, the techniques of this disclosure may both immediately enable the training of language models for all supported keyboard languages, and quickly personalize the language models to each user.

As discussed above, LM module 228 may output the one or more candidate words from the lexicon data that have the highest similarity coefficients and/or the one or more candidate emoji symbols from the lexicon data that have the highest similarity coefficients. In some examples, LM module 228 may output a combined list of candidates that includes the one or more candidate words and/or emoji symbols from the lexicon data that have the highest similarity coefficients. For instance, if a first candidate word has a similarity coefficient of 85, a second candidate word has a similarity coefficient of 63, a third candidate word has a similarity coefficient of 58, a first candidate emoji symbol has a similarity coefficient of 81, and a second candidate emoji symbol has a similarity coefficient of 55, LM module 228 may output a combined list that includes the first candidate word, the second candidate word, and the first candidate emoji symbol.

As discussed above, keyboard module 222 may cause UI module 220 to display the most probable candidates (e.g., emoji symbols, words, and/or phrases) within suggestion regions, and, responsive to receiving information indicating a selection of a particular suggestion region of the displayed suggestion regions, keyboard module 222 may modify the text within an edit region based on the candidate displayed within the particular suggestion region. However, when the candidate displayed within the particular suggestion region is an emoji symbol, it may not be desirable for keyboard module 222 to always modify text within edit region by replacing the portion of the text that corresponds to the candidate emoji symbol with the candidate emoji symbol. For instance, in some examples, it may be desirable to append the candidate emoji symbol to the portion of the text that corresponds to the candidate emoji symbol because replacing the portion of the text that corresponds to the candidate emoji symbol with the candidate emoji symbol may obfuscate the meaning of the text/emoji symbol (e.g., where the candidate emoji symbol modifies the meaning of the text or vice versa). On the other hand, in some examples, it may be desirable for keyboard module 222 to modify the text within the edit region by replacing the portion of the text that corresponds to the candidate emoji symbol with the candidate emoji symbol because it may be redundant to include both the portion of the text that corresponds to the candidate emoji symbol and the candidate emoji symbol (e.g., where the candidate emoji symbol is a pictograph of the portion of the text).

In accordance with one or more techniques of this disclosure, rather than always replacing the portion of the text that corresponds to the candidate emoji symbol with the candidate emoji symbol or always appending the candidate emoji symbol to the portion of the text, keyboard module 222 may selectively determine whether to replace the portion of the text that corresponds to the candidate emoji symbol with the candidate emoji symbol or append the candidate emoji symbol to the portion of the text. For instance, LM module 228 may determine whether to append or replace based on an emoji-trained language model, such as the emoji-trained language model used by LM module 228 to predict the candidate emoji symbol.

In any case, keyboard module 222 may modify the text by either replacing the portion of the text with the candidate emoji symbol or appending the candidate emoji symbol to the portion of the text and cause UI module 220 to display the modified text. For instance, keyboard module 222 may cause UI module 220 to display the modified text in an edit region, such as edit region 116C of GUI 114A.

As discussed above, LM module 228 may determine whether to modify the text by replacing the portion of the text with the candidate emoji symbol or appending the candidate emoji symbol to the portion of the text. As one example, LM module 228 may make the append/replace determination generally for all emoji symbols. For instance, LM module 228 may determine whether portions of text are typically replaced (e.g., based on global or local rules) by emoji symbols or whether emoji symbols are typically appended to portions of text. In such examples, when a candidate emoji symbol is selected, keyboard module 222 may always replace portions of text with the candidate emoji symbol or always append candidate emoji symbol to the portions of text regardless of which emoji symbol is the candidate emoji symbol and regardless of what is included in the portions of text.

As another example, LM module 228 may make the append/replace determination separately for each particular emoji symbol. For instance, LM module 228 may determine whether portions of text are typically replaced (e.g., based on global or local rules) by a particular emoji symbol or whether the particular emoji symbol is typically appended to portions of text. In such examples, when a selected candidate emoji is a particular emoji symbol, keyboard module 222 may always replace portions of text with the particular emoji symbol or always append the particular emoji symbol to the portions of text regardless of what is included in the portions of text.

As another example, LM module 228 may make the append/replace determination separately for each combination of text and emoji symbol. For instance, LM module 228 may determine whether a particular portion of text is typically replaced by a particular emoji symbol or whether the particular emoji symbol is typically appended to the particular portion of text. In such examples, when a selected candidate emoji for a particular portion of text is a particular emoji symbol, keyboard module 222 may always replace the particular portion of text with the particular emoji symbol or always append the particular emoji symbol to the particular portion of text.

As discussed above, LM module 228 may assign a language model probability or a similarity coefficient to one or more candidate emoji symbols and output the one or more candidate emoji symbols from the lexicon data that have the highest similarity coefficients. In some examples, each of the candidate emoji symbols determined by LM module 228 may include a single emoji symbol. For instance, based on the text “I know nothing”, LM module 228 may determine a first candidate emoji symbol that includes the see-no-evil monkey emoji (e.g., Unicode U+1F648), a second candidate emoji symbol that includes the hear-no-evil monkey emoji (e.g., Unicode U+1F649), and a third candidate emoji symbol that includes the speak-no-evil monkey emoji (e.g., Unicode U+1F64A). In some examples, one or more of the candidate emoji symbols determined by LM module 228 may be a candidate emoji phrase that includes a plurality of emoji symbols that are collectively predicted to correspond to the portion of the text. For instance, based on the text “I know nothing”, LM module 228 may determine a candidate emoji phrase that includes all of the see-no-evil monkey emoji (e.g., Unicode U+1F648) the hear-no-evil monkey emoji (e.g., Unicode U+1F649), and the speak-no-evil monkey emoji (e.g., Unicode U+1F64A), and determine a candidate emoji symbol that includes the zipper-mouth face emoji (e.g., Unicode U+1F910).

Where the selected candidate is an emoji phrase, LM module 228 may determine whether to modify the text by replacing the portion of the text with the candidate emoji phrase or appending the candidate emoji phrase to the portion of the text. Similar to the determination for candidate emoji symbols, LM module 228 may make the append/replace determination generally for all emoji phrases, separately for each particular emoji phrase, or separately for each combination of text and emoji phrase.

In some examples, LM module 228 may base the append/replace determination on a current context of computing device 210. As used herein, a current context specifies the characteristics of the physical and/or virtual environment of a computing device, such as computing device 210, and a user of the computing device, at a particular time. In addition, the term “contextual information” is used to describe any information that can be used by a computing device to define the virtual and/or physical environmental characteristics that the computing device, and the user of the computing device, may experience at a particular time.

Examples of contextual information are numerous and may include: sensor information obtained by sensors (e.g., position sensors, accelerometers, gyros, barometers, ambient light sensors, proximity sensors, microphones, and any other sensor) of computing device 210, communication information (e.g., text based communications, audible communications, video communications, etc.) sent and received by communication modules of computing device 210, and application usage information associated with applications executing at computing device 210 (e.g., application data associated with applications, Internet search histories, text communications, voice and video communications, calendar information, social media posts and related information, etc.). Further examples of contextual information include signals and information obtained from transmitting devices that are external to computing device 210.

In addition to relying on the text of a current message being input at computing device 210, LM module 228 may rely previous words, sentences, etc. associated with previous messages sent and/or received by computing device 210 to determine whether or append or replace. In other words, LM module 228 may rely on the text of an entire conversation including multiple messages that computing device 210 has sent and received to determine whether to append or replace an emoji symbol in a current conversation.

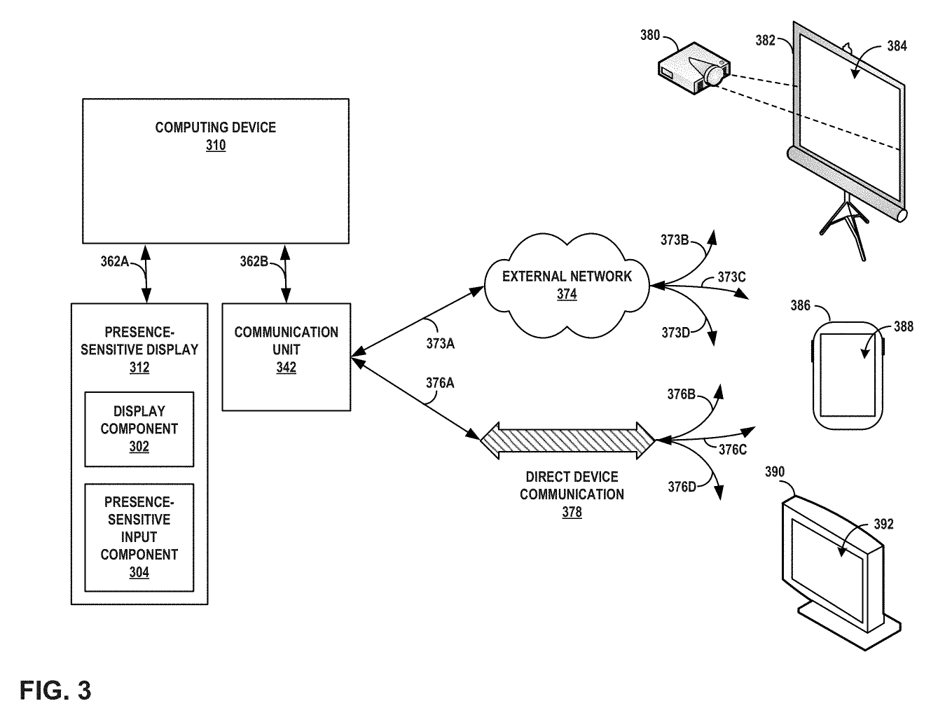

FIG. 3 is a block diagram illustrating an example computing device that outputs graphical content for display at a remote device, in accordance with one or more techniques of the present disclosure. Graphical content, generally, may include any visual information that may be output for display, such as text, images, or a group of moving images, to name only a few examples. The example shown in FIG. 3 includes a computing device 310, a PSD 312, communication unit 342, projector 380, projector screen 382, mobile device 386, and visual display component 390. In some examples, PSD 312 may be a presence-sensitive display as described in FIGS. 1-2. Although shown for purposes of example in FIGS. 1 and 2 as a stand-alone computing device 110 and computing device 210, a computing device such as computing device 310 may, generally, be any component or system that includes a processor or other suitable computing environment for executing software instructions and, for example, need not include a presence-sensitive display.

As shown in the example of FIG. 3, computing device 310 may be a processor that includes functionality as described with respect to processors 240 in FIG. 2. In such examples, computing device 310 may be operatively coupled to PSD 312 by a communication channel 362A, which may be a system bus or other suitable connection. Computing device 310 may also be operatively coupled to communication unit 342, further described below, by a communication channel 362B, which may also be a system bus or other suitable connection. Although shown separately as an example in FIG. 3, computing device 310 may be operatively coupled to PSD 312 and communication unit 342 by any number of one or more communication channels.

In other examples, such as illustrated previously by computing device 110 in FIGS. 1A-1E or computing device 210 in FIG. 2, a computing device may refer to a portable or mobile device such as mobile phones (including smart phones), laptop computers, etc. In some examples, a computing device may be a desktop computer, tablet computer, smart television platform, camera, personal digital assistant (PDA), server, or mainframes.

PSD 312 may include display component 302 and presence-sensitive input component 304. Display component 302 may, for example, receive data from computing device 310 and display the graphical content. In some examples, presence-sensitive input component 304 may determine one or more user inputs (e.g., continuous gestures, multi-touch gestures, single-touch gestures) at PSD 312 using capacitive, inductive, and/or optical recognition techniques and send indications of such user input to computing device 310 using communication channel 362A. In some examples, presence-sensitive input component 304 may be physically positioned on top of display component 302 such that, when a user positions an input unit over a graphical element displayed by display component 302, the location at which presence-sensitive input component 304 corresponds to the location of display component 302 at which the graphical element is displayed.

As shown in FIG. 3, computing device 310 may also include and/or be operatively coupled with communication unit 342. Communication unit 342 may include functionality of communication unit 242 as described in FIG. 2. Examples of communication unit 342 may include a network interface card, an Ethernet card, an optical transceiver, a radio frequency transceiver, or any other type of device that can send and receive information. Other examples of such communication units may include Bluetooth, 3G, and Wi-Fi radios, Universal Serial Bus (USB) interfaces, etc. Computing device 310 may also include and/or be operatively coupled with one or more other devices (e.g., input devices, output components, memory, storage devices) that are not shown in FIG. 3 for purposes of brevity and illustration.

FIG. 3 also illustrates a projector 380 and projector screen 382. Other such examples of projection devices may include electronic whiteboards, holographic display components, and any other suitable devices for displaying graphical content. Projector 380 and projector screen 382 may include one or more communication units that enable the respective devices to communicate with computing device 310. In some examples, the one or more communication units may enable communication between projector 380 and projector screen 382. Projector 380 may receive data from computing device 310 that includes graphical content. Projector 380, in response to receiving the data, may project the graphical content onto projector screen 382. In some examples, projector 380 may determine one or more user inputs (e.g., continuous gestures, multi-touch gestures, single-touch gestures) at projector screen using optical recognition or other suitable techniques and send indications of such user input using one or more communication units to computing device 310. In such examples, projector screen 382 may be unnecessary, and projector 380 may project graphical content on any suitable medium and detect one or more user inputs using optical recognition or other such suitable techniques.

Projector screen 382, in some examples, may include a presence-sensitive display 384. Presence-sensitive display 384 may include a subset of functionality or all of the functionality of presence-sensitive display 112 and/or 312 as described in this disclosure. In some examples, presence-sensitive display 384 may include additional functionality. Projector screen 382 (e.g., an electronic whiteboard), may receive data from computing device 310 and display the graphical content. In some examples, presence-sensitive display 384 may determine one or more user inputs (e.g., continuous gestures, multi-touch gestures, single-touch gestures) at projector screen 382 using capacitive, inductive, and/or optical recognition techniques and send indications of such user input using one or more communication units to computing device 310.

FIG. 3 also illustrates mobile device 386 and visual display component 390. Mobile device 386 and visual display component 390 may each include computing and connectivity capabilities. Examples of mobile device 386 may include e-reader devices, convertible notebook devices, hybrid slate devices, etc. Examples of visual display component 390 may include other devices such as televisions, computer monitors, etc. In some examples, visual display component 390 may be a vehicle cockpit display or navigation display (e.g., in an automobile, aircraft, or some other vehicle). In some examples, visual display component 390 may be a home automation display or some other type of display that is separate from computing device 310.

As shown in FIG. 3, mobile device 386 may include a presence-sensitive display 388. Visual display component 390 may include a presence-sensitive display 392. Presence-sensitive displays 388, 392 may include a subset of functionality or all of the functionality of presence-sensitive display 112, 212, and/or 312 as described in this disclosure. In some examples, presence-sensitive displays 388, 392 may include additional functionality. In any case, presence-sensitive display 392, for example, may receive data from computing device 310 and display the graphical content. In some examples, presence-sensitive display 392 may determine one or more user inputs (e.g., continuous gestures, multi-touch gestures, single-touch gestures) at projector screen using capacitive, inductive, and/or optical recognition techniques and send indications of such user input using one or more communication units to computing device 310.

As described above, in some examples, computing device 310 may output graphical content for display at PSD 312 that is coupled to computing device 310 by a system bus or other suitable communication channel. Computing device 310 may also output graphical content for display at one or more remote devices, such as projector 380, projector screen 382, mobile device 386, and visual display component 390. For instance, computing device 310 may execute one or more instructions to generate and/or modify graphical content in accordance with techniques of the present disclosure. Computing device 310 may output the data that includes the graphical content to a communication unit of computing device 310, such as communication unit 342. Communication unit 342 may send the data to one or more of the remote devices, such as projector 380, projector screen 382, mobile device 386, and/or visual display component 390. In this way, computing device 310 may output the graphical content for display at one or more of the remote devices. In some examples, one or more of the remote devices may output the graphical content at a presence-sensitive display that is included in and/or operatively coupled to the respective remote devices.

In some examples, computing device 310 may not output graphical content at PSD 312 that is operatively coupled to computing device 310. In other examples, computing device 310 may output graphical content for display at both a PSD 312 that is coupled to computing device 310 by communication channel 362A, and at one or more remote devices. In such examples, the graphical content may be displayed substantially contemporaneously at each respective device. For instance, some delay may be introduced by the communication latency to send the data that includes the graphical content to the remote device. In some examples, graphical content generated by computing device 310 and output for display at PSD 312 may be different than graphical content display output for display at one or more remote devices.

Computing device 310 may send and receive data using any suitable communication techniques. For example, computing device 310 may be operatively coupled to external network 374 using network link 373A. Each of the remote devices illustrated in FIG. 3 may be operatively coupled to network external network 374 by one of respective network links 373B, 373C, or 373D. External network 374 may include network hubs, network switches, network routers, etc., that are operatively inter-coupled thereby providing for the exchange of information between computing device 310 and the remote devices illustrated in FIG. 3. In some examples, network links 373A-373D may be Ethernet, ATM or other network connections. Such connections may be wireless and/or wired connections.

In some examples, computing device 310 may be operatively coupled to one or more of the remote devices included in FIG. 3 using direct device communication 378. Direct device communication 378 may include communications through which computing device 310 sends and receives data directly with a remote device, using wired or wireless communication. That is, in some examples of direct device communication 378, data sent by computing device 310 may not be forwarded by one or more additional devices before being received at the remote device, and vice-versa. Examples of direct device communication 378 may include Bluetooth, Near-Field Communication, Universal Serial Bus, Wi-Fi, infrared, etc. One or more of the remote devices illustrated in FIG. 3 may be operatively coupled with computing device 310 by communication links 376A-376D. In some examples, communication links 376A-376D may be connections using Bluetooth, Near-Field Communication, Universal Serial Bus, infrared, etc. Such connections may be wireless and/or wired connections.

In accordance with techniques of the disclosure, computing device 310 may be operatively coupled to visual display component 390 using external network 374. Computing device 310 may output a graphical keyboard for display at PSD 312. For instance, computing device 310 may send data that includes a representation of the graphical keyboard to communication unit 342. Communication unit 342 may send the data that includes the representation of the graphical keyboard to visual display component 390 using external network 374. Visual display component 390, in response to receiving the data using external network 374, may cause PSD 392 to output the graphical keyboard. In response to receiving a user input at PSD 392 to select one or more keys of the keyboard, visual display device 130 may send an indication of the user input to computing device 310 using external network 374. Communication unit 342 of may receive the indication of the user input, and send the indication to computing device 310.

Computing device 310 may select, based on the user input, one or more keys. Computing device 310 may determine, based on the selection of one or more keys, text. In some examples, computing device 310 may predict a candidate emoji symbol that corresponds to at least a portion of the determined text. Computing device 310 may output a representation of an updated graphical user interface including an updated graphical keyboard. The updated graphical keyboard may include an edit region that includes the text and a suggestion region that includes the predicted candidate emoji symbol. Communication unit 342 may receive the representation of the updated graphical user interface and may send the send the representation to visual display component 390, such that visual display component 390 may cause PSD 312 to output the updated graphical keyboard, including the edit region and the suggestion region that includes the predicted candidate emoji symbol. In response to receiving a user input at PSD 312 to select the suggestion region that includes the predicted candidate emoji symbol, visual display device 130 may send an indication of the user input to computing device 310 using external network 374. Communication unit 342 of may receive the indication of the user input, and send the indication to computing device 310.

Computing device 310 may modify, based on the user input, the text by either replacing the portion of the text with the candidate emoji symbol or appending the candidate emoji symbol to the portion of the text. In some examples, computing device 310 may determine whether to modify the text by replacing the portion of the text with the candidate emoji symbol or appending the candidate emoji symbol to the portion of the text based on an emoji-trained language model. Computing device 310 may output a representation of an updated graphical user interface including an updated graphical keyboard. The updated graphical keyboard may include an edit region that includes the modified text. Communication unit 342 may receive the representation of the updated graphical user interface and may send the send the representation to visual display component 390, such that visual display component 390 may cause PSD 312 to output the updated graphical keyboard, including the edit region that includes the modified text.

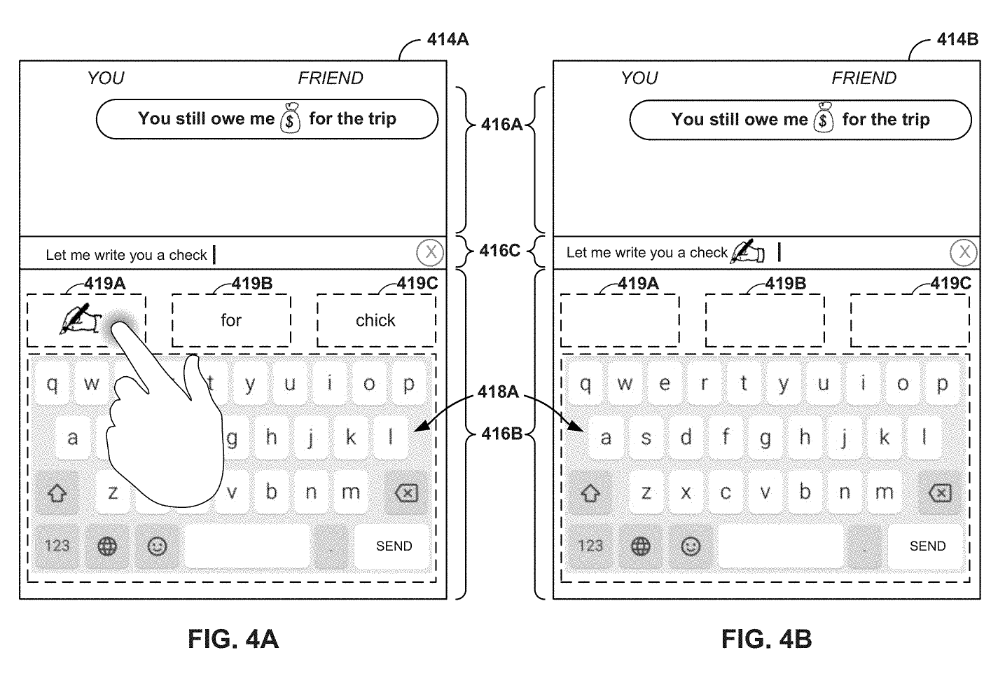

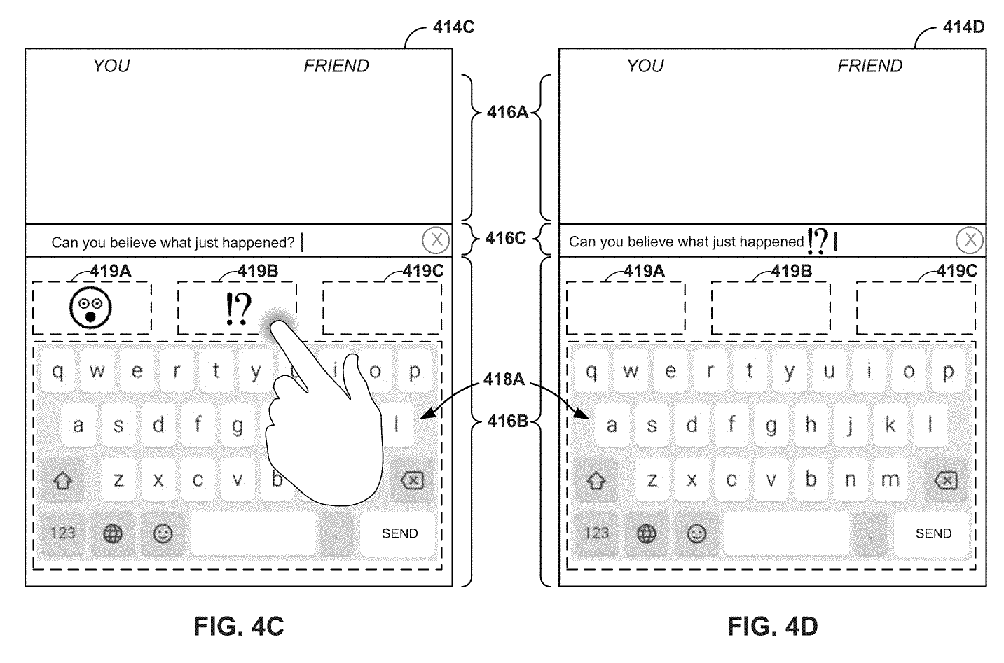

FIGS. 4A-4D are conceptual diagrams illustrating example graphical user interfaces of an example computing device that is configured to present a graphical keyboard with integrated emoji suggestions, in accordance with one or more aspects of the present disclosure. FIGS. 4A-4D illustrate, respectively, example graphical user interfaces 414A-414D (collectively, “user interfaces 414”). However, many other examples of graphical user interfaces 414 may be used in other instances. Each of graphical user interfaces 414 may correspond to a graphical user interface displayed by computing devices 110 or 210 of FIGS. 1 and 2 respectively. Each of user interfaces 414 includes output region 416A, graphical keyboard 416B, and edit region 416C. Graphical keyboard 416B, in each of user interfaces 414, includes suggestion regions 419A-419C (collectively, “suggestion regions 419”) and graphical keys 418A. FIGS. 4A-4D are described below in the context of computing device 110.

In the example of FIGS. 4A and 4B, user interfaces 414A and 414B show how in some examples, computing device 110 may selectively append, rather than replace, a selected candidate emoji symbol to text. For example, as shown in FIG. 4A, computing device 110 may display, within edit region 416C, text entered by a user of computing device 110 (e.g., “Let me write you a check”). Based at least in part on the text displayed in edit region 416C, computing device 110 may predict a candidate emoji symbol that corresponds to at least a portion of the text displayed in edit region 416C (e.g., a writing hand emoji, such as Unicode U+270D), candidate text (e.g., “for” and “chick”). Computing device 110 may display, within suggestion regions 419, the predicted candidates. A user may provide a tap input at or near the location of suggestion region 419A. In response to the tap input at suggestion region 419A, computing device 110 may automatically modify the text shown within edit region 416C based on the candidate emoji symbol displayed within suggestion region 419A.

Next, as shown in FIG. 4B and in accordance with one or more techniques of this disclosure, computing device 110 may determine whether to modify the text by replacing a portion of the text shown within edit region 416C with the candidate emoji symbol or appending the candidate emoji symbol to the portion of the text shown within edit region 416C. In the example of FIGS. 4A and 4B, computing device 110 may determine to append the candidate emoji symbol to the portion of the text shown within edit region 416C. In this case, by appending the candidate emoji symbol to the text, computing device 110 may preserve the meaning of the message (where as replacing “write you a check” with the writing hand emoji would obfuscate the meaning of the message).

In the example of FIGS. 4C and 4D, user interfaces 414C and 414D show how in some examples, computing device 110 may selectively replace text with a selected candidate emoji symbol. For example, as shown in FIG. 4C, computing device 110 may display, within edit region 416C, text entered by a user of computing device 110 (e.g., “Can you believe what just happened?”). Based at least in part on the text displayed in edit region 416C, computing device 110 may predict a first candidate emoji symbol that corresponds to at least a portion of the text displayed in edit region 416C (e.g., an exclamation question mark emoji, such as Unicode U+2049), and a second candidate emoji symbol that corresponds to at least a portion of the text displayed in edit region 416C (e.g., an astonished face emoji, such as Unicode U+1F632). Computing device 110 may display, within suggestion region 419A and 419B, the predicted candidate emoji symbols. A user may provide a tap input at or near the location of suggestion region 419B. In response to the tap input at suggestion region 419B, computing device 110 may automatically modify the text shown within edit region 416C based on the candidate emoji symbol displayed within suggestion region 419B.

Next, as shown in FIG. 4D and in accordance with one or more techniques of this disclosure, computing device 110 may determine whether to modify the text by replacing a portion of the text shown within edit region 416C with the candidate emoji symbol or appending the candidate emoji symbol to the portion of the text shown within edit region 416C. In the example of FIGS. 4C and 4D, computing device 110 may determine to replace a portion of the text shown within edit region 416C that corresponds to the selected candidate emoji symbol (e.g., the question mark) with the candidate emoji symbol. In this case, by replacing the portion of the text that corresponds to the candidate emoji symbol, computing device 110 may remove redundancy from the message (where appending an exclamation question mark emoji to a question mark would be redundant).

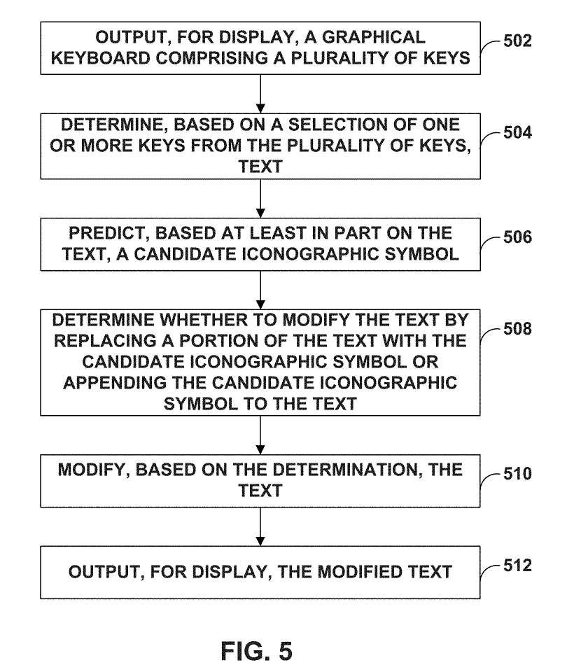

FIG. 5 is a flowchart illustrating example operations of a computing device that is configured to present a graphical keyboard with integrated iconographic suggestions, in accordance with one or more aspects of the present disclosure. The operations of FIG. 5 may be performed by one or more processors of a computing device, such as computing devices 110 of FIG.1 or computing device 210 of FIG. 2. For purposes of illustration only, FIG. 5 is described below within the context of computing devices 110 of FIGS. 1A-1E.

In operation, computing device 110 may output, for display, a graphical keyboard comprising a plurality of keys (502). For example, computing device 110 may cause PSD 112 to present user interface 114A including graphical keyboard 116B and edit region 116C. Graphical keyboard 116B may include keys 118A and suggestion regions 119.

Computing device 110 may determine, based on a selection of one or more keys from the plurality of keys, text (504). For example, a user may provide tap and/or gesture input at or near locations of PSD 112 at which keys 118A are displayed. A language and/or spatial model of keyboard module 122 may determine, based on touch events received from UI module 120 and PSD 112, one or more words that the user may be entering based on the input at PSD 112. In some examples, keyboard module 122 may cause UI module 120 to display the determined one or more words within edit region 116C.

Computing device 110 may predict, based at least in part on the text, a candidate iconographic symbol (506). For example, keyboard module 122 may use an iconographic—trained language model to determine one or more iconographic symbols with the highest score or likelihood of corresponding to at least a portion of the text. In some examples, the candidate iconographic symbol predicted by computing device 110 may be a candidate emoji symbol.

Computing device 110 may determine whether to modify the text by replacing a portion of the text with the candidate iconographic symbol or appending the candidate iconographic symbol to the text (508). For example, keyboard module 122 may use the iconographic-trained language model (e.g., the emoji-trained language model) to determine whether the candidate emoji symbol is typically appended to the text or whether a portion of the text is typically replaced by the candidate iconographic symbol.

Computing device 110 may modify, based on the determination, the text (510). As one example, where the candidate iconographic symbol is typically appended to the text, keyboard module 122 may modify the text by appending the candidate iconographic symbol to the text, such as in the examples of FIGS. 1B, 1C, 4A, and 4B. As another example, where a portion of the text is typically replaced by the candidate iconographic symbol, keyboard module 122 may modify the text by replacing the portion of the text with the candidate iconographic symbol, such as in the examples of FIGS. 1D, 1E, 4C, and 4D.

Computing device 110 may output, for display, the modified text (512). For example, keyboard module 122 may cause UI module 120 to display the modified text within edit region 116C.

The following numbered clauses may illustrate one or more aspects of the disclosure:

Clause 1. A method comprising: outputting, by a mobile computing device, for display, a graphical keyboard comprising a plurality of keys; determining, by the mobile computing device, based on a selection of one or more keys from the plurality of keys, text; predicting, by the mobile computing device and based at least in part on the text, a candidate iconographic symbol; determining, by the mobile computing device, whether to modify the text by replacing a portion of the text with the candidate iconographic symbol or appending the candidate iconographic symbol to the text; modifying, by the mobile computing device and based on the determining, the text by either replacing the portion of the text with the candidate iconographic symbol or appending the candidate iconographic symbol to the text; and outputting, by the mobile computing device and for display at the display device, the modified text.

Clause 2. The method of clause 1, wherein the candidate iconographic symbol comprises a candidate iconographic phrase that includes a plurality of iconographic symbols that are collectively predicted to correspond to the portion of the text.

Clause 3. The method of any combination of clauses 1-2, further comprising: outputting, by the mobile computing device, for display, the candidate iconographic symbol; and modifying the text in response to receiving, by the mobile computing device, an indication of a gesture to select the candidate iconographic symbol.

Clause 4. The method of any combination of clauses 1-3, wherein predicting the candidate iconographic symbol that corresponds to the portion of the text comprises: predicting, based on an iconographic-trained language model, the candidate iconographic symbol.

Clause 5. The method of any combination of clauses 1-4, wherein determining whether to modify the text by replacing the portion of the text with the candidate iconographic symbol or appending the candidate iconographic symbol to the text comprises: determining, based on the iconographic-trained language model, whether to modify the text by replacing the portion of the text with the candidate iconographic symbol or appending the candidate iconographic symbol to the text.

Clause 6. The method of any combination of clauses 1-5, further comprising: determining whether portions of text are typically replaced by the particular candidate iconographic symbol or whether the particular iconographic symbol is typically appended to text; and determining to modify the text by replacing the portion of the text with the candidate iconographic symbol where portions of text are typically replaced by the particular candidate iconographic symbol; or determining to modify the text by appending the candidate iconographic symbol to the text where the particular iconographic symbol is typically appended to text.

Clause 7. The method of any combination of clauses 1-5, further comprising: determining whether portions of text are typically replaced by iconographic symbols or whether iconographic symbols are typically appended to text; and determining to modify the text by replacing the portion of the text with the candidate iconographic symbol where portions of text are typically replaced by iconographic symbols; or determining to modify the text by appending the candidate iconographic symbol to the text where iconographic symbols are typically appended to text.

Clause 8. The method of any combination of clauses 1-7, wherein the candidate iconographic symbol comprises a candidate emoji symbol.

Clause 9. A system comprising means for performing any of the methods of clauses 1-8.

Clause 10. A computing device comprising means for performing any of the methods of clauses 1-8.

Clause 11. A computer-readable storage medium storing instructions that, when executed, cause one or more processors of a mobile computing device to perform the method of any combination of clauses 1-8.

Throughout the disclosure, examples are described where a computing device and/or a computing system analyzes information (e.g., context, locations, speeds, search queries, etc.) associated with a computing device and a user of a computing device, only if the computing device receives permission from the user of the computing device to analyze the information. For example, in situations discussed below, before a computing device or computing system can collect or may make use of information associated with a user, the user may be provided with an opportunity to provide input to control whether programs or features of the computing device and/or computing system can collect and make use of user information (e.g., information about a user's current location, current speed, etc.), or to dictate whether and/or how to the device and/or system may receive content that may be relevant to the user. In addition, certain data may be treated in one or more ways before it is stored or used by the computing device and/or computing system, so that personally-identifiable information is removed. For example, a user's identity may be treated so that no personally identifiable information can be determined about the user, or a user's geographic location may be generalized where location information is obtained (such as to a city, ZIP code, or state level), so that a particular location of a user cannot be determined. Thus, the user may have control over how information is collected about the user and used by the computing device and computing system.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

What is claimed is:

1. A method comprising:
outputting, by a mobile computing device, for display, a graphical keyboard comprising a plurality of keys;
determining, by the mobile computing device, based on a selection of one or more keys from the plurality of keys, text;
predicting, by the mobile computing device and based at least in part on the text, a candidate iconographic symbol;
determining, by the mobile computing device, whether to modify the text by replacing a portion of the text with the candidate iconographic symbol or appending the candidate iconographic symbol to the text;
modifying, by the mobile computing device and based on the determining, the text by either replacing the portion of the text with the candidate iconographic symbol or appending the candidate iconographic symbol to the text; and
outputting, by the mobile computing device and for display at the display device, the modified text.

2. The method of claim 1, wherein the candidate iconographic symbol comprises a candidate iconographic phrase that includes a plurality of iconographic symbols that are collectively predicted to correspond to the portion of the text.

3. The method of claim 1, further comprising:
outputting, by the mobile computing device, for display, the candidate iconographic symbol; and
modifying the text in response to receiving, by the mobile computing device, an indication of a gesture to select the candidate iconographic symbol.

4. The method of claim 1, wherein predicting the candidate iconographic symbol that corresponds to the portion of the text comprises:
predicting, based on an iconographic -trained language model, the candidate iconographic symbol.

5. The method of claim 4, wherein determining whether to modify the text by replacing the portion of the text with the candidate iconographic symbol or appending the candidate iconographic symbol to the text comprises:
determining, based on the iconographic -trained language model, whether to modify the text by replacing the portion of the text with the candidate iconographic symbol or appending the candidate iconographic symbol to the text.

6. The method of claim 1, further comprising:
determining whether portions of text are typically replaced by the particular candidate iconographic symbol or whether the particular iconographic symbol is typically appended to text; and
determining to modify the text by replacing the portion of the text with the candidate iconographic symbol where portions of text are typically replaced by the particular candidate iconographic symbol; or
determining to modify the text by appending the candidate iconographic symbol to the text where the particular iconographic symbol is typically appended to text.

7. The method of claim 1, further comprising:
determining whether portions of text are typically replaced by iconographic symbols or whether iconographic symbols are typically appended to text; and
determining to modify the text by replacing the portion of the text with the candidate iconographic symbol where portions of text are typically replaced by iconographic symbols; or
determining to modify the text by appending the candidate iconographic symbol to the text where iconographic symbols are typically appended to text.

8. The method of claim 1, wherein the candidate iconographic symbol comprises a candidate emoji symbol.

9. A mobile computing device comprising:
a presence-sensitive display;
at least one processor; and
a memory comprising instructions that, when executed by the at least one processor, cause the at least one processor to:
output for display, a graphical keyboard comprising a plurality of keys;
determine based on a selection of one or more keys from the plurality of keys, text;
predict, based at least in part on the text, a candidate iconographic symbol;
determine whether to modify the text by replacing a portion of the text with the candidate iconographic symbol or appending the candidate iconographic symbol to the text;
modify, based on the determination, the text by either replacing the portion of the text with the candidate iconographic symbol or appending the candidate iconographic symbol to the text; and
output, for display, the modified text.

10. The mobile computing device of claim 9, wherein the candidate iconographic symbol comprises a candidate iconographic phrase that includes a plurality of iconographic symbols that are collectively predicted to correspond to the portion of the text.

11. The mobile computing device of claim 9, wherein the instructions, when executed, cause the at least one processor to:
output, for display, the candidate iconographic symbol; and
modify the text in response to receiving an indication of a gesture to select the candidate iconographic symbol.

12. The mobile computing device of claim 9, wherein the instructions that cause the at least one processor to predict the candidate iconographic symbol that corresponds to the portion of the text comprise instructions that cause the at least one processor to:
predict, based on an iconographic -trained language model, the candidate iconographic symbol.

13. The mobile computing device of claim 12, wherein the instructions that cause the at least one processor to determine whether to modify the text by replacing the portion of the text with the candidate iconographic symbol or appending the candidate iconographic symbol to the text comprise instructions that cause the at least one processor to:
determine, based on the iconographic -trained language model, whether to modify the text by replacing the portion of the text with the candidate iconographic symbol or appending the candidate iconographic symbol to the text.

14. The mobile computing device of claim 9, wherein the candidate iconographic symbol comprises a candidate emoji symbol.

15. A computer-readable storage medium encoded with instructions that, when executed by at least one processor of a mobile computing device, cause the at least one processor to:
output for display, a graphical keyboard comprising a plurality of keys;
determine based on a selection of one or more keys from the plurality of keys, text;
predict, based at least in part on the text, a candidate iconographic symbol;
determine whether to modify the text by replacing a portion of the text with the candidate iconographic symbol or appending the candidate iconographic symbol to the text;
modify, based on the determination, the text by either replacing the portion of the text with the candidate iconographic symbol or appending the candidate iconographic symbol to the text; and
output, for display, the modified text.

16. The computer-readable storage medium of claim 15, wherein the candidate iconographic symbol comprises a candidate iconographic phrase that includes a plurality of iconographic symbols that are collectively predicted to correspond to the portion of the text.

17. The computer-readable storage medium of claim 15, wherein the instructions, when executed, cause the at least one processor to:
output, for display, the candidate iconographic symbol; and
modify the text in response to receiving an indication of a gesture to select the candidate iconographic symbol.

18. The computer-readable storage medium of claim 15, wherein the instructions that cause the at least one processor to predict the candidate iconographic symbol that corresponds to the portion of the text comprise instructions that cause the at least one processor to:
predict, based on an iconographic -trained language model, the candidate iconographic symbol.

19. The computer-readable storage medium of claim 18, wherein the instructions that cause the at least one processor to determine whether to modify the text by replacing the portion of the text with the candidate iconographic symbol or appending the candidate iconographic symbol to the text comprise instructions that cause the at least one processor to:
determine, based on the iconographic -trained language model, whether to modify the text by replacing the portion of the text with the candidate iconographic symbol or appending the candidate iconographic symbol to the text.

20. The computer-readable storage medium of claim 15, wherein the instructions, when executed, cause the at least one processor to:
determine whether portions of text are typically replaced by the particular candidate iconographic symbol or whether the particular iconographic symbol is typically appended to text; and
determine to modify the text by replacing the portion of the text with the candidate iconographic symbol where portions of text are typically replaced by the particular candidate iconographic symbol; or
determine to modify the text by appending the candidate iconographic symbol to the text where the particular iconographic symbol is typically appended to text.

21. The computer-readable storage medium of claim 15, wherein the instructions, when executed, cause the at least one processor to:
determine whether portions of text are typically replaced by iconographic symbols or whether iconographic symbols are typically appended to text; and
determine to modify the text by replacing the portion of the text with the candidate iconographic symbol where portions of text are typically replaced by iconographic symbols; or
determine to modify the text by appending the candidate iconographic symbol to the text where iconographic symbols are typically appended to text.

22. The computer-readable storage medium of claim 15, wherein the candidate iconographic symbol comprises a candidate emoji symbol.
